(19) United States
(12) Patent Application Publication
(10) Pub. No.: US 2020/0129005 A1
(43) Pub. Date: Apr. 30, 2020

(54) OVEN AND COOKING METHOD FOR THE FOOD SERVICE INDUSTRY WITH REMOTE CONTROL AND PROGRAMMING UNIT

(71) Applicant: ALI GROUP SRL, CERNUSCO SUL NAVIGLIO (MI) (IT)

(72) Inventors: Moreno Zanchetta, Vittorio Veneto (IT); Oscar Imazio, San Pietro di Feletto (IT)

(21) Appl. No.: 16/666,156

(22) Filed: Oct. 28, 2019

Related U.S. Application Data
(60) Provisional application No. 62/751,025, filed on Oct. 26, 2018.

(51) Int. Cl. A47J 36/32; F24C 14/00; F24C 15/32; A47J 27/12

(52) U.S. Cl. CPC A47J 36/321; A47J 27/12; F24C 15/322; F24C 14/005

(57) ABSTRACT

An oven and cooking method is provided. The oven comprises a washing system with controlled feeding, distribution and recirculation means of a detergent liquid in the cooking chamber and with means for the removal of the detergent from the cooking chamber. The oven also has a device for flavouring food and a logic unit that communicates with the user via the Internet for remote access, instruction, monitoring, and control.

### FIELD OF THE INVENTION

The present invention relates to a professional oven for cooking food in the food service industry and related method, in particular industrial ovens for cooking food, such as the ovens for restaurants and large kitchens, for example an electrical, gas or steam oven, of the convection or mixed type for cooking food, which is provided with a remote control and programming unit.

### BACKGROUND OF THE INVENTION

In the field of the food service industry there is the need to resort to equipment for cooking food, such as ovens, provided on the one side with a good thermal yield for a faster and more uniform cooking minimizing consumptions, but on the other side above all able to provide in one single integrated oven a good versatility of use according to the chefs growing and variable needs, for example the fact of being able to roast, braise, grill, brown or sauté the food being cooked, and so on, not excluding the possibility to simultaneously treat various kinds of food, different by nature and size. Often, in the traditional organization of a chef there is the need to programme or modify in advance the food cooking cycles, a circumstance that mostly requires the presence of the chef in the place where the apparatus is located, at least for the start of the cooking cycle, although this can obviously occur afterwards by determining in advance the required time by means of a conventional timer.

In the same way, the intervention by the chef on-site and by any maintenance operators is required for other activities, for example for a change in the cooking cycle, or for the simple implementation or update of the functions of the logic unit on the basis of new modes of cooking or uploading of recipes in the database of the logic unit.

Said professional ovens for the food service industry are mainly large, and have a coating structure or external body which is in the shape of a parallelepiped and which on its inside comprises a cooking chamber. Said cooking chamber is accessible by means of a door that can be opened and vice-versa on the front of said oven, by means of conventional opening/closing means and inside there are dedicated components, such as at least one air recirculation fan, heating means and so on, which vary depending on the configuration of the oven. Finally, outside the oven, on the side of the front, a control panel is provided, which by means of a logic unit interfaced with the user, manages all the functions of the oven.

Considering the increasingly evolved use of professional ovens, manufacturers tend to insert in the electronic interfaces of management of the devices a number of programs or pre-set cooking processes in order to facilitate the use of the oven also by non-expert personnel or to give indications and suggestions to the chefs who use the oven in an evolved way. The programs or cooking processes can be modifiable or non-modifiable or have some cooking parameters, such as the temperature in the chamber, cooking time, core temperature, level of moisture, all these parameters being modifiable according to some pre-defined ranges to obtain variations in the final result without making mistakes. They can also be accompanied by additional information such as context, ingredients, preparation, presentation.

The known interfaces also provide the possibility to manage the data detected during cooking and record it in the internal memory of the device or electronic management unit of the oven so that it can be recalled and referred to the single cooking processes carried out in compliance with the HACCP standard requirements. A further option of these electronic interfaces is to enable a complete control of the oven, not only of the functions manageable by the user but also of those dedicated to the technical part, that is to say, the control of the parameters and the configuration of the apparatus, the carrying out of functional tests, the management and the setting of the alarms, and other functions.

The following prior art references will now be discussed:

D1—CN202432564 (U) (Jibao)

D2—CN102100479 (A) (Wei)

D3—US2008087663 (A1) (Mansbery et al.)

D4—CA2354964 (A1) (Smith)

D5—US 2010/205295 (Dietmayer)

D6—WO 2013/150330 (Convotherm)

D7—Ser. No. 03/038,652 (Salton)

Reference D1 proposes a microwave electrical multi-function oven, which comprises a facade, a cooking chamber, a grid, a heating device and a temperature control probe, wherein said oven can be controlled by a remote control via Bluetooth.

Reference D2 describes a remote control intelligent cooking system. In the system, an electric cooker, a stewpot, a microwave oven and a computer are connected by a data line. If one of the electric cooker, the stewpot and the microwave oven does not operate normally, other cooking appliances are not influenced, and after receiving instructions from users, the computer transmits cooking commands to the corresponding cooking appliances by the data line, so that the cooking appliances start to operate.

Reference D3 discloses a self-contained refrigerator and oven, for refrigerating and cooking food in the same enclosed chamber, which can be actuated by the operator from a variety of remote locations around the world via telephone or the Internet. The heating element may be a microwave unit and the refrigerating means may be a thermoelectric heat pump.

Reference D4 describes a control method through a smart network of an electric household appliance, allowing a user to select a desired sequence of instructions to be carried out by a remote appliance. The sequence of instructions contains commands to be executed both by the user and by the appliance, regulated by a CPU, with a pause sequence when user input is required and wherein the commands of the appliance are executed automatically. When said method is applied to a cooking appliance, such as an oven, the appliance executes some cooking functions automatically according to a recipe which is followed by a CPU.

Reference D5 synthetically describes a system for synchronous monitoring of a cooking process of a plurality of cooking devices via the internal web browser of one of the cooking devices, said system comprising a plurality of cooking devices that can be interconnected via interfaces and wherein each cooking device is connected to at least one internal web server that is connected to a network and that provides services for the monitoring, control or analysis of at least one of the cooking devices, and wherein at least one internal web browser is provided that is connected to the network and that can use at least the services of one of the internal web servers.

Reference D6 synthetically describes a cleaning system for cleaning a cavity of a food or beverage preparation device, said cavity being connected with a pipe system, wherein the pipe system supplies a fluid through the pipe system to the cavity; when the fluid flow stops, any remainder of the fluid in the pipe system is removed by passing a gas (for example, air) through the pipe system or by a valve disposed at a high location of the pipe system.

Reference D7 synthetically describes a solution in which a breadmaker receives a plurality of program recipes from a network that are executed by scanning with a scanner a symbol and associating the scanned symbol with one of the plurality of program recipes while keeping a real-time clock synchronized and correctly set by receiving period time synchronization messages.

Therefore, cloud computing technologies are known. In particular, by using various types of hardware and software, one allows the client, in the form of a service proposed by a third provider, to save or store and/or to process data by means of CPU or software, exploiting resources distributed and displayed in the network, for example on the Internet, by means of a standard client-server architecture.

There are obvious drawbacks to the prior art disclosures. In the sector of conventional ovens it is possible to reasonably state that the above-described functions are normally managed by the electronic device on the oven and, therefore, any customizations and variations are managed locally. Said devices can also interact with the external world through some connections with PCs, generally by means of supervision software, in the most evolved cases also remotely using Internet connections, or by means of memory supports such as USB sticks or memory cards. Said interactions are normally intended to update the software, to detect data, such as data on cooking for the HACCP standard, to check the machine status and any errors, or they can have the function of uploading and downloading some programs or cooking methods, interventions which act as a functional and technical configuration of the apparatus.

This configuration, in some cases of widespread use of professional appliances, as for example in the case of supermarket chains or catering centres, must be extended in a homogenous way on different appliances for obvious reasons of uniformity of operation and of management of the recipes.

The main drawbacks of this way of managing the professional appliance mainly lie in the fact that each variation, change or update, both of technical and of functional nature, is specific for the single appliance and can be shared or detected only by means of dedicated supervision software or transferred by means of memory supports such as USB sticks or memory cards, namely external interventions with respect to the appliance. For example, the variations in the programs and cooking processes or the uploading or cancellation thereof are of the resident domain of the oven in which they are carried out and the above-described connections are required if one wants to transfer them. In conclusion, it is possible to state that the appliance, except for network connections under supervision software, operates in a stand-alone mode.

### OBJECT OF THE INVENTION

This and other aims are achieved by the present invention according to the characteristics as in the appended claims by means of a professional oven for cooking food in the food service industry and related method, wherein said oven comprises a cooking chamber closable by a door which is vertically hinged with respect to the body of the oven, and with inside the cooking chamber at least one air recirculation fan; at least one heating device; a washing system with controlled feeding, distribution and recirculation means of the detergent liquid in the cooking chamber and with means for the removal of said liquid from said cooking chamber; a device for flavouring food, and a logic unit of the oven, said logic unit of the oven being intended to communicate in a client mode by means of the Internet with a cloud unit of data processing and exchange common to other ovens, in such a way as to enable dedicated access upon username and password recognition, and wherein at least the main server is connected to said cloud unit.

The proposed solution undoubtedly achieves various advantages and aims. A simple connection to the Internet, for example via Wi-Fi or through an Ethernet cable, enables the nearly total management and configuration of the oven without further accessories, in real time and with all the above-listed features. It is very useful for the final user for the management of their oven both locally and remotely, as well as for technicians for the detection of the machine statuses and of the alarms during the maintenance phases (also remotely), up to the coordinators/managers of supermarket chains or catering centres who can manage the configuration of several ovens simultaneously in an efficient, fast and synchronized way. With respect to the known solutions it enables a constant contact between the producing company and the final user, giving the possibility of having a two-way exchange of information and to keep the user constantly up-to-date. Therefore, cloud computing becomes a meeting point between companies and users, a focal point in which the information conveyed by the company converges and in which clients can find their own dedicated space for the management and constant update of their professional oven for cooking food or professional system of ovens for cooking food.

### BRIEF DESCRIPTION OF THE DRAWINGS

FIG. 1 illustrates an interface flow diagram of the appliance with the network cloud unit.

FIG. 2 illustrates a schematic view of an example of screen with access to the recipe database of the network cloud unit.

FIG. 3 illustrates a schematic view of an additional example of screen with access to the recipe database of the network cloud unit.

FIG. 4 illustrates a schematic view of an additional example of screen with access to the recipe database of the network cloud unit.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity.

### DETAILED DESCRIPTION OF THE INVENTION

Reference will now be made in detail to the presently preferred embodiments of the invention. There are also representative examples of the invention illustrated in the accompanying drawings. Throughout the following detailed description, the same reference numeral refers to the same elements in all figures.

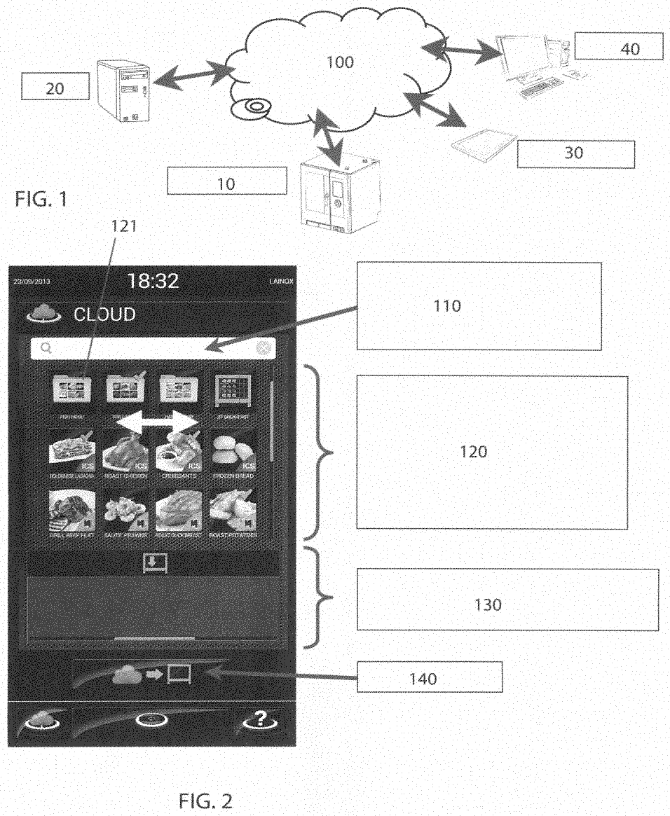

In an oven (10) for the professional cooking of food intended for the food service industry (FIG. 1) there is a body which also acts as an external coating, in the shape of a parallelepiped, respectively made up of a back side of the oven, two parallel sides, a bottom, and a front. The front comprises the door, which, by means of the vertical hinge, is hinged to the body of the oven (10), providing access to the inside of the cooking chamber.

Said cooking chamber, closed by said door in correspondence of the front of the oven (10), along the perimeter, has a shape developing on three sides orthogonal with respect to one another, respectively a back wall and two side walls, respectively a right and a left wall. Spaced apart from the side wall or from the back wall there is a deflector in such a way as to house in the intermediate area at least one recirculation fan, which is moved by a motor placed in a space distinct from the cooking chamber, wherein said technical space is at a controlled temperature, in such a way as to not influence the electronic and electromechanical components governing the operation of the oven (10). Finally, there are also means for generating the heating of the cooking chamber, in such a way as to enable the heating of said cooking chamber by means of electrical resistors, gas or steam, or in a combined mode. Said oven (10) also comprises a washing system of the cooking chamber and/or of the boiler and also a device for flavouring food.

The solution according to the present invention (FIG. 1), by adopting the cloud unit (100), allows, through a connection to the Internet managed directly by the processing logic unit of the oven (10), for example via Wi-Fi or through an Ethernet cable, to remotely connect said oven (10) to at least the server (20) with which, by means of said cloud unit (100), it shares all or part of the data in a synchronized way. In particular, from said oven (10) it will be possible to access this function upon access by username and password recognition, in such a way as to access said company server (20), made available by the oven producing company or by a third party by means of the cloud unit (100), and through which it is possible to operate directly from the appliance (10) in order to access a series of services controlled by said company server (20). In the same way, one can possibly connect to said cloud unit (100) a tablet (30) as well a personal computer of the user (40), or a smartphone, in such a way that access to said cloud unit (100) is possible from any place in which the user is.

The most advantageous services, which can be provided in this way, are:
possibility to create a copy (also synchronized) of the profile of one's appliance (10);
possibility to manage one's profile also from further remote accesses through tablets (30) and/or PCs (40);
access to a predefined database from said server (20) containing many cooking programs downloadable free of charge and in constant evolution, and which are constantly updated and increased with new publications. Said programs can also be accompanied by a series of additional information such as context, ingredients, preparation, presentation, all contained in the downloadable program;
possibility to download software and interface application updates;
monitoring of the machine status (10) by authorized technicians;
possibility to download the recorded cooking data (HACCP);
possibility to reproduce the created profile in other appliances (10) (supermarket chains or catering centers).

With respect to FIG. 2, which shows an example of user interface screen, the proposed architecture proposes in the first user field (110) of the cloud unit (100) the possibility to filter the view of the recipes, for example by highlighting the fields in which to search, by typing the recipe name, the country, the folder of belonging, in which there is the subdivision into first courses, main courses, desserts, etc. In the field below (120) there is a drop-down list of the folders of recipes (121), called for example “Recipes”, present in said cloud unit (100). The use of the touch screen function allows to act directly on the related folder (121) to open it and see and select its contents. For example, those already present in the oven (10) and/or whose download has just been completed are ticked in different colours. The lower area with respect to the field (120) of the screen of FIG. 2 includes a field (130) dedicated to the download function, and is an area in which the folders of recipes and/or the recipes that one wants to download in the oven (10) are dragged. The further lower part provides a button (140), intended for the start of the download function.

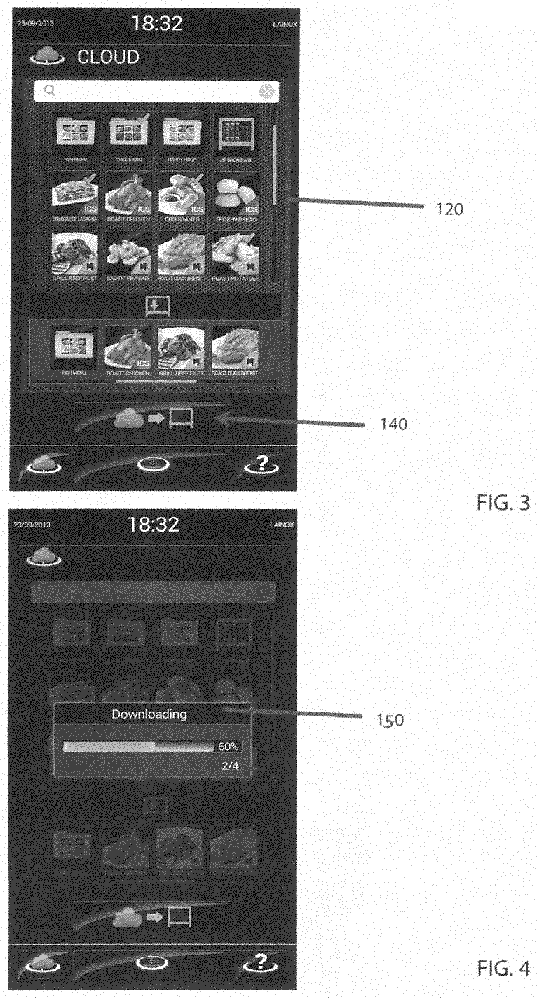

Operatively, FIG. 3 shows the next step with respect to the screen of FIG. 2, wherein, by pressing on each single folder, it is possible to see its contents. Once selected, the folders of recipes/the recipes are dragged from the display field (120) in the download area (130). The additional control of the download area (130) can be useful in order to check whether one or more files uploaded in the field (130) are correct, in such a way that, once the correctness of the desired data has been assessed, it is possible to press the download start button (140) which will transfer the selected data to the logic unit of the professional oven (10).

FIG. 4 shows a further next step with respect to the screen of FIG. 3, in which download start is represented by a pop-up (150) which indicates some data, such as:
Download progress bar
Percentage of downloaded file
Number of downloaded recipes/Number of recipes

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An oven comprising:
a cooking chamber comprising an oven body and a door, wherein said door is vertically hinged with respect to said oven body and sealably closes said oven;
at least one recirculation fan located within said cooking chamber;
means for heating said oven;
a washing system;
a device for flavoring food; and
a logic unit that communicates via the Internet with a remote computer server.

2. The oven of claim 1 wherein said washing system comprises a system for controlled feeding, distribution and recirculation of a liquid detergent and removal of said detergent from said cooking chamber.

3. The oven of claim 2 wherein said logic unit is configured to receive automated cooking instructions from said server based on a user profile.

4. The oven of claim 3 wherein said logic unit is further configured to receive cooking data common to other ovens.

5. The oven of claim 3 further comprising a user interface screen in communication with said logic unit, wherein said logic unit is further configured to receive additional information regarding a cooking procedure from said remote computer server and to display said additional information on said screen.

6. The oven of claim 5 wherein said logic unit is further configured to receive cooking data common to other ovens.

7. The oven of claim 3 wherein said logic unit is further configured to receive application updates from said remote computer server.

8. The oven of claim 7 wherein said logic unit is further configured to receive cooking data common to other ovens.

9. The oven of claim 3 wherein said logic unit is further configured to transmit a status of said oven to remotely located technicians via said remote computer server.

10. The oven of claim 9 wherein said logic unit is further configured to receive cooking data common to other ovens.

11. The oven of claim 10 wherein said logic unit is further configured to transmit recorded cooking data to said remote computer server.
